(19) United States
(12) Patent Application Publication
(10) Pub. No.: US 2023/0390830 A1
(43) Pub. Date: Dec. 7, 2023

(54) CUTTING INSERT AND CUTTING TOOL EQUIPPED WITH CUTTING INSERT

(71) Applicant: TUNGALOY CORPORATION, Fukushima (JP)

(72) Inventor: Atsushi OGAWA, Iwaki-shi (JP)

(73) Assignee: TUNGALOY CORPORATION, Fukushima (JP)

(21) Appl. No.: 18/181,904

(22) Filed: Mar. 10, 2023

(30) Foreign Application Priority Data
Jun. 3, 2022 (JP) 2022-090922

(51) Int. Cl. B23B 27/16

(52) U.S. Cl. CPC B23B 27/1611; B23B 2200/049; B23B 2200/0447; B23B 2200/283

(57) ABSTRACT

A cutting insert which can be used with a total of 4 cutting edges being switched over, and of which thickness can still be reduced, and a cutting tool equipped with this cutting insert are provided. The cutting insert includes: a pair of first constraining surfaces which face each other in a rotating direction of a body; a pair of second constraining surfaces which face each other in a direction toward a rotational center axis of the body; cutting edges disposed respectively along a pair of sides located at positions facing each other, of sides framing the first constraining surface; and flanks which are disposed at positions adjacent to the cutting edges respectively in the rotating direction. In this cutting insert, an angle formed by the first constraining surface and the flank, which are adjacent to each other across the cutting edge, is larger than 90°.

### BACKGROUND

### Field

The present invention relates to a cutting insert and a cutting tool equipped with the cutting insert.

### Description of Related Art

As a cutting tool to cut, for example, an inner surface of a pipe, a cutting tool equipped with a plurality of cutting inserts arranged in the circumferential direction on the peripheral side of a rotating body is known. Each of the cutting inserts can be removed from the body and replaced. For example, as disclosed in Japanese Patent No. 5779830, a plurality of cutting edges are disposed in one cutting insert, and a cutting edge to be used for machining is switched over by changing the mounting state of this cutting insert on the body.

### SUMMARY

For example, in a configuration where a cutting edge to be used for machining can be changed by rotating the cutting insert 180° around an axis perpendicular to a rotational center axis of a body, two cutting edges located at diagonal positions are switched over and used.

In a case of a configuration where these cutting inserts can be mounted in reverse positions, a total of four cutting edges can be switched over for use. In this configuration, however, the cutting insert may become too thick, and machining a small diameter workpiece may become difficult.

It is an object of the present invention to provide: a cutting insert which can be used with switching a total of four cutting edges and of which thickness can still be reduced; and a cutting tool equipped with this cutting insert.

A cutting insert according to an aspect of the present invention is a cutting insert which is capable of being mounted on a body of a cutting tool, the cutting insert including: first constraining surfaces, which are a pair of surfaces facing each other in a rotating direction of the body, and one of which is constrained by the body; second constraining surfaces, which are a pair of surfaces facing each other in a direction toward a rotational center axis of the body, and one of which is constrained by the body; cutting edges disposed respectively along a pair of sides, which extend from one of the second constraining surfaces to the other of the second constraining surfaces, and are located at positions facing each other, of sides framing the first constraining surface; and flanks which are disposed at positions adjacent to the cutting edges respectively in the rotating direction. In the cutting insert, an angle formed by the first constraining surface and the flank, which are adjacent to each other across the cutting edge, is larger than 90°.

In the cutting insert having this configuration, two cutting edges are disposed along two sides of one of the first constraining surfaces, and two more cutting edges are disposed along two sides of the other of the first constraining surfaces. Thereby a total of four cutting edges can be switched and used by changing direction and the like when the cutting insert is mounted on the body.

In the cutting insert having the above configuration, an angle formed by two surfaces (first constraining surface and flank), which are adjacent to each other with the cutting edge therebetween, is larger than 90°. Therefore while the shape of each first constraining surface is a parallelogram, so as to reduce the thickness of the cutting insert, the flat flank can connect between one of the first constraining surfaces and the other of the first constraining surfaces.

It is preferable that a breaker is disposed between the cutting edge and the first constraining surface, and an angle formed by an inner surface of the breaker and the flank, which are adjacent to each other across the cutting edge, is 90° or less.

It is preferable that in a case where, of the sides framing the first constraining surface, a side on the second constraining surface side, is a first side and a side on the cutting edge side thereof is a second side, an angle formed by the first side and the second side is an angle that is different from 90°.

It is preferable that shapes of the two first constraining surfaces are the same as each other, and shapes of the two second constraining surfaces are the same as each other.

It is preferable that a shape of the cutting insert after turning 180° around a predetermined symmetric axis is superimposed on a shape before the turning.

It is preferable that a margin, which is a portion that contacts with an inner side surface of a hole during machining, is formed linearly along the side of the second constraining surface on the first constraining surface side.

It is preferable that the margin is formed to be parallel with the rotational center axis of the body in a state of the cutting insert being mounted on the body.

It is preferable that the cutting tool is equipped with the cutting insert according to any one of the above aspects.

According to the present invention, a cutting insert, which can be used with switching a total of four cutting edges and of which thickness can still be reduced, and a cutting tool equipped with this cutting insert, can be provided.

### BRIEF DESCRIPTION OF DRAWINGS

FIG. 1 is a diagram depicting a configuration of a cutting insert according to Embodiment 1 and a cutting tool equipped with the cutting insert;

FIG. 2 is a diagram depicting a configuration of the cutting insert according to Embodiment 1 and the cutting tool equipped with the cutting insert;

FIG. 3 is a diagram depicting a configuration of the cutting insert according to Embodiment 1;

FIG. 4 is a diagram depicting a configuration of the cutting insert according to Embodiment 1;

FIG. 5 is a diagram depicting a configuration of the cutting insert according to Embodiment 1, and is a diagram viewed from the opposite side of FIG. 4;

FIG. 6 is a diagram depicting a configuration of the cutting insert according to Embodiment 1;

FIG. 7 is a diagram depicting a configuration of the cutting insert according to Embodiment 1;

FIG. 8 is a diagram depicting a configuration of the cutting insert according to Embodiment 1;

FIG. 9 is a diagram depicting a configuration of a cutting insert according to a comparative example and a cutting tool equipped with the cutting insert;

FIG. 10 is a diagram depicting a configuration of a cutting insert according to another comparative example;

FIG. 11 is a diagram depicting a configuration of a cutting insert according to Embodiment 2, and a cutting tool equipped with the cutting insert;

and

FIG. 12 is a diagram depicting a configuration of a cutting insert according to Embodiment 3.

### DETAILED DESCRIPTION

Embodiments of the present invention will be described with reference to the accompanying drawings. In each drawing, a same composing element is denoted with a same reference sign and redundant description is omitted as much as possible, so as to make description more easily understood.

Embodiment 1 will now be described. A cutting tool 10 according to Embodiment 1 is a milling tool that cuts an inner surface of a pipe or the like while rotating, and is also called a “pull counter boring tool”. The configuration of the cutting tool 10, to be described below, is applicable to other milling tools.

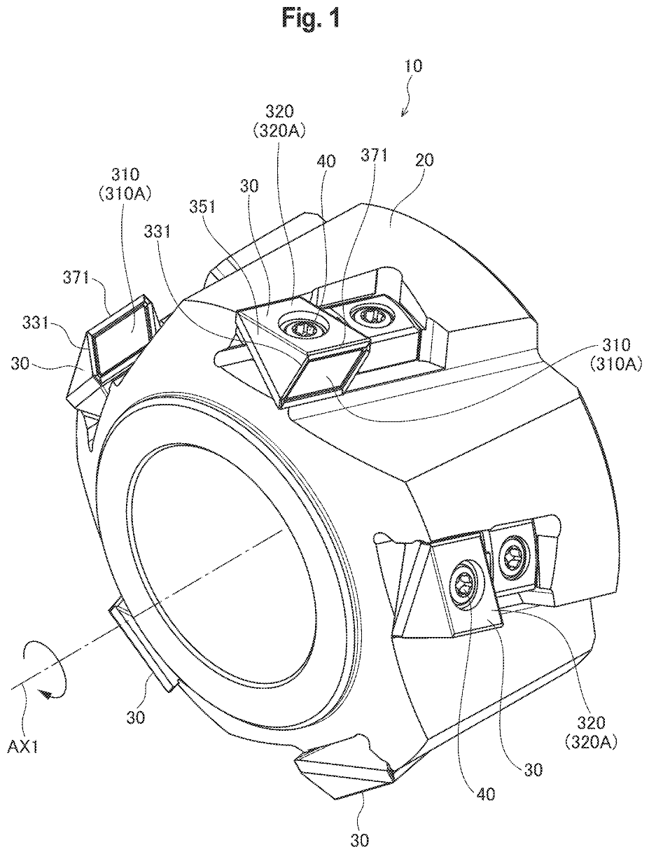

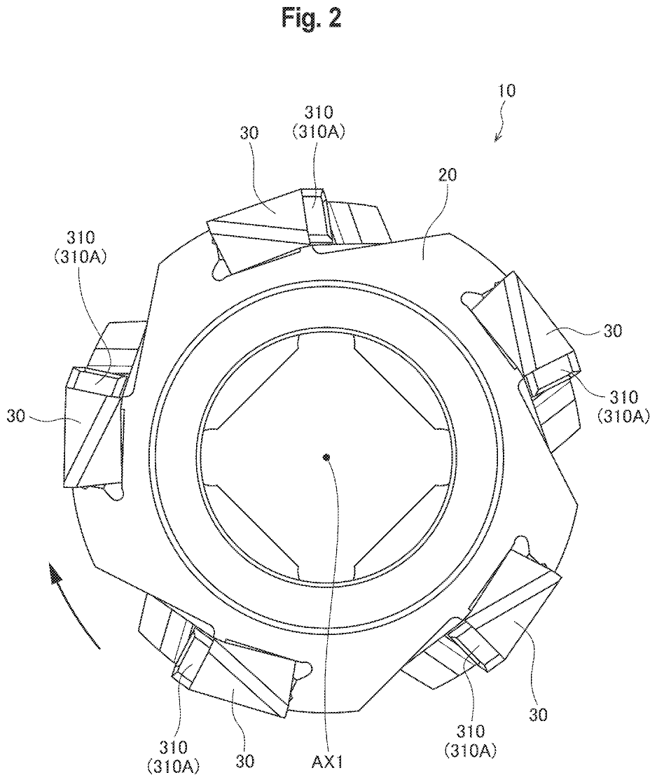

FIG. 1 is a perspective view of an appearance of the cutting tool 10. FIG. 2 is a diagram of a cutting tool 10 of FIG. 1 viewed from a leading end side along the rotational center axis AX1. As illustrated in FIG. 1 and FIG. 2, the cutting tool 10 includes a plurality of cutting inserts 30, which are mounted on a body 20.

The body 20 is a body part of the cutting tool 10, and is held by a machining tool (not illustrated) together with a holder in a state of being mounted on the holder (e.g. arbor). The body 20 has roughly a cylindrical shape, and the center axis thereof matches with the rotational center axis AX1. During machining, the body 20 rotates around the rotational center axis AX1 by a driving force of the machine tool. In FIG. 1 and FIG. 2, this rotating direction is indicated by the arrow mark.

A cutting insert 30 is a member in which a cutting edge 331 and the like, are disposed. As mentioned above, a plurality of cutting inserts 30 are disposed on the peripheral side of the body 20, so as to line up in the circumferential direction at equal intervals. Each cutting insert 30 is fastened to the body 20 by a screw 40. The shape of each cutting insert 30 is the same.

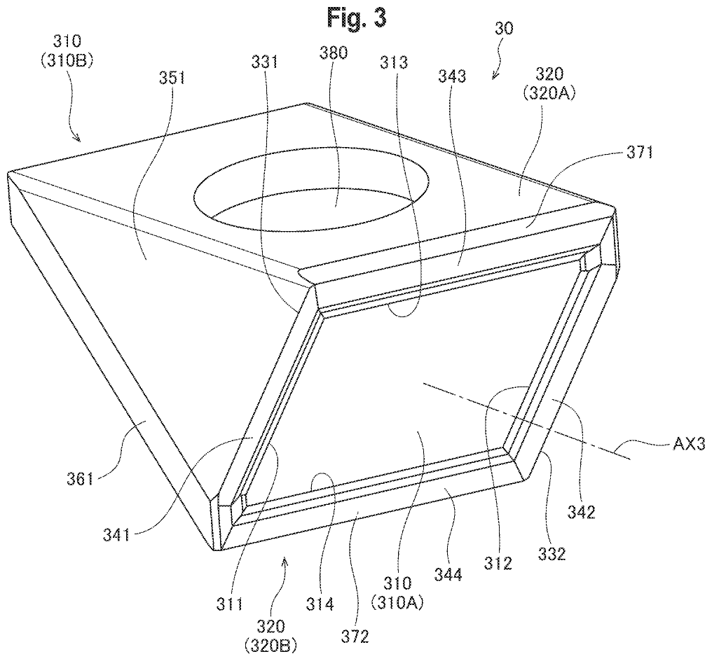

The configuration of the cutting insert 30 will be described with reference to FIG. 3 and the like. As illustrated in FIG. 3, the cutting insert 30 includes first constraining surfaces 310 and second constraining surfaces 320.

The first constraining surfaces 310 are a pair of surfaces facing each other in the rotating direction of the body 20. In other words, the cutting insert 30 has two first constraining surfaces 310. As illustrated in FIG. 1, in the state where the cutting insert 30 is mounted on the body 20, the first constraining surface 310 disposed on the front side in the rotating direction is called a “first constraining surface 310A” in the following description. Further, the first constraining surface 310 disposed on the rear side in the rotating direction is called a “first constraining surface 310B” in the following description. In the state in FIG. 1, the first constraining surface 3108 is in contact with the body 20, whereby the position of the cutting insert 30 in the rotating direction is constrained.

As described later, the cutting insert 30 has a rotationally symmetric shape, and can also be mounted on the body 20 in a direction that is different from that in FIG. 1. For example, the cutting insert 30 may be mounted in a state where the side of the first constraining surface 310A is in contact with the body 20. In any case, the pair of first constraining surfaces 310A and 310B face each other in the rotating direction of the body 20. As described above, the first constraining surfaces 310A and 3108 face each other in the rotating direction of the body 20, and either one becomes a surface constrained by the body 20.

The second constraining surfaces 320 are a pair of surfaces facing each other in a direction toward the rotational center axis AX of the body 20. In other words, the cutting insert 30 has two second constraining surfaces 320. As illustrated in FIG. 1, in the state where the cutting insert 30 is mounted on the body 20, the second constraining surface 320 disposed on the opposite side (outer side) of the body 20 is called a “second constraining surface 320A” in the following description. Further, the second constraining surface 320 disposed on the body 20 side (inner side) is called a “second constraining surface 320B”. In the state in FIG. 1, the second constraining surface 320B is in contact with the body 20, whereby the position of the cutting insert 30 in the diameter direction is constrained. The shapes of the second constraining surfaces 320A and 320B are roughly rectangular and are congruent with each other.

As described above, the cutting insert 30 can also be mounted on the body 20 in a direction that is different from that in FIG. 1. For example, the cutting insert 30 may be mounted in a state where the side of the second constraining surface 320A is in contact with the body 20. In any case, the pair of the second constraining surfaces 320A and 320B face each other in the direction toward the rotational center axis AX of the body 20. As described above, the second constraining surfaces 320A and 320B face each other in the direction toward the rotational center axis AX of the body 20, and either one becomes a surface constrained by the body 20.

In the cutting insert 30, a through hole 380, that penetrates from the second constraining surface 320A to the second constraining surface 320B, is formed. The through hole 380 is a circular hole to which a screw 40 in FIG. 1 is inserted for fastening the cutting insert 30. The diameter of the through hole 380 is smaller than the diameter of a head part of the screw 40, and is larger than the diameter of the screw part (shaft part) of the screw 40, so that the cutting insert 30 can be fastened using the head part of the screw 40. The through hole 380 also has a diameter-expanded portion corresponding to the shape of the head part of the screw 40.

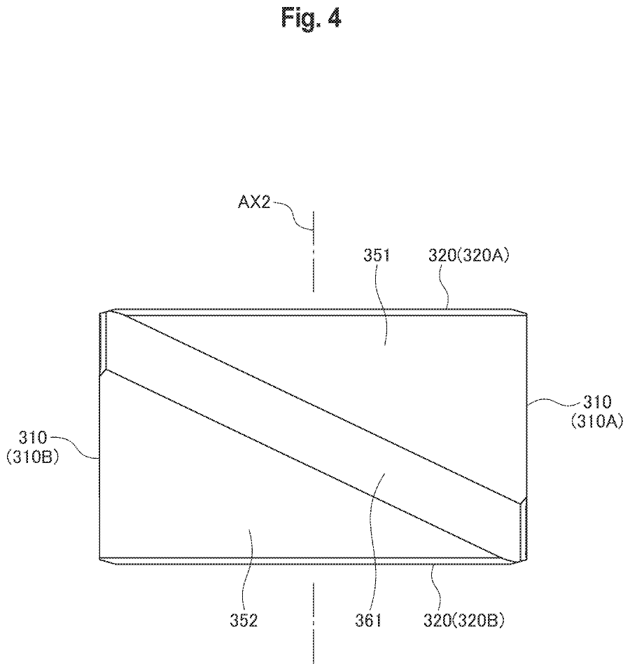

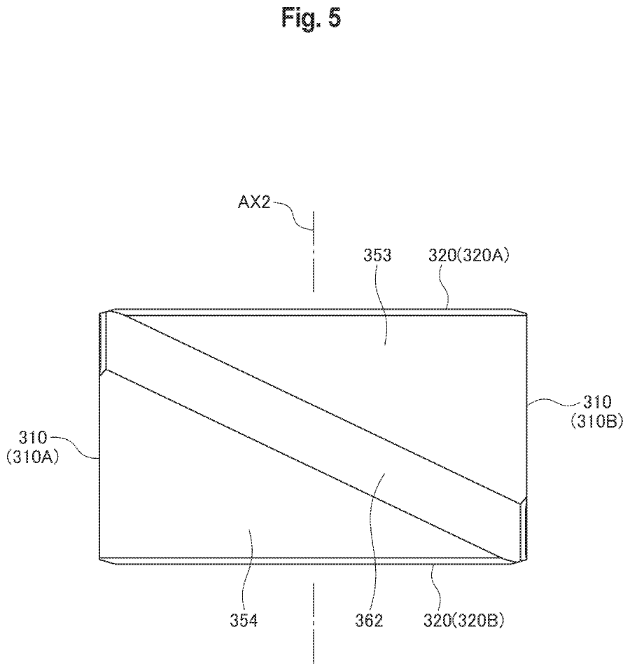

As illustrated in FIG. 4 and FIG. 5, the first constraining surfaces 310A and 3108 are parallel with each other, and the second constraining surfaces 320A and 320B are also parallel with each other. The first constraining surfaces 310 and the second constraining surfaces 320 are perpendicular to each other. The center axis AX2 of the through hole 380 is an axis that is perpendicular to the second constraining surfaces 320A and 320B respectively, and passes through the center of these surfaces respectively.

As illustrated in FIG. 3 and the like, in the cutting insert 30, cutting edges 331 and 332 and breakers 341 and 342 are disposed, so as to roughly form a parallelogram as a whole, and as a result, the shape of the first constraining surface 310 formed on the inner side of these elements roughly becomes a parallelogram (but not a rectangle). The shapes of the first constraining surfaces 310A and 310B are congruent with each other (roughly a parallelogram). Therefore if the cutting insert 30 is rotated 180° around the center axis AX2, the first constraining surface 310A is completely superimposed on the position of the first constraining surface 310B before the rotation, and the first constraining surface 310B is completely superimposed on the position of the first constraining surface 310A before the rotation. By this configuration, the entire thickness of the cutting insert 30 (that is, the distance from the first constraining surface 310A to the first constraining surface 310B) is reduced.

Since the first constraining surfaces 310A and 310B are congruent with each other, only the configuration of the first constraining surface 310A and the neighboring area thereof will be described here, and description on the first constraining surface 310B and the neighboring area thereof will be omitted unless necessary.

As illustrated in FIG. 3, the first constraining surface 310A is framed by four sides: 311, 312, 313 and 314. Both sides 311 and 312 extend from one second constraining surface 320A to the other second constraining surface 320B. The sides 311 and 312 are a pair of sides disposed facing each other.

Both sides 313 and 314 extend along the second constraining surfaces 320. The sides 313 and 314 are a pair of sides disposed facing each other, just like the above mentioned sides 311 and 312.

As mentioned above, the shape of the first constraining surface 310A is roughly a parallelogram. Therefore if, out of the above mentioned 4 sides, the side 314 on the second constraining surface 320B side is assumed to be a “first side’, and the side 311 on the cutting edge 331 side is assumed to be a “second side’, an angle formed by the first side and the second side is an angle less than 90°. Further, if the side 314 on the second constraining surface 320B side is assumed to be a “first side”, and the side 312 on the cutting edge 332 side is assumed to be a “second side”, an angle formed by the first side and the second side is an angle larger than 90°. In either case, an angle formed by the first side and the second side is an angle that is different from 90°. This is the same in the case where the side 313 is assumed to be a “first side”, and the side 311 or 312 is assumed to be a “second side”.

In the mounting state in FIG. 1, the cutting edge 331 used for cutting extends along the side 311. However, the side 311 and the cutting edge 331 are separated, and a breaker 341 is formed therebetween. The breaker 341 is a recessed groove that is disposed to adjust an angle formed by 2 surfaces (inner surface of the breaker 341 and later mentioned flank 351), which are adjacent to each other with the cutting edge 331 therebetween, so as to ensure a rake angle similar to a prior art. The breaker 341 may also have a function to break chips generated during machining.

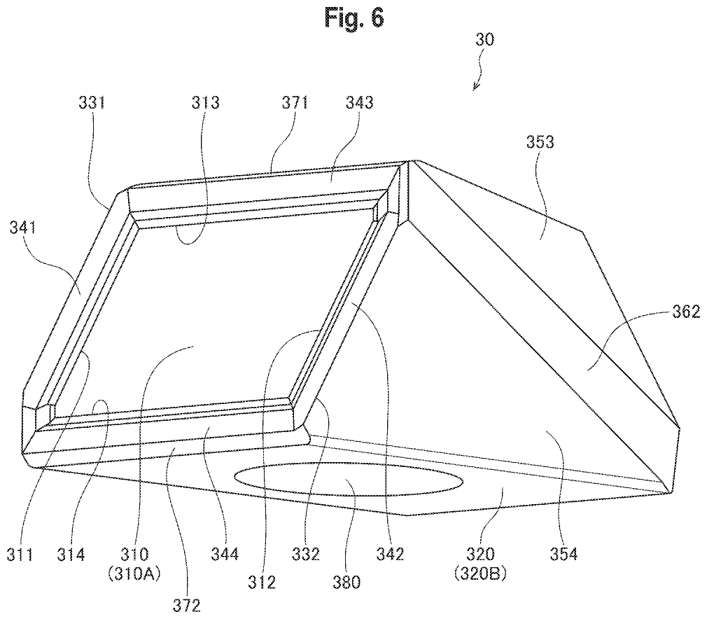

As illustrated in FIG. 6, a cutting edge 332, the same as the cutting edge 331, is also formed on the outer side of the side 312. The cutting edge 332 extends along the side 312, and a breaker 342 is formed between the side 312 and the cutting edge 332. The cutting edge 332, however, is not used for cutting in the mounted state of FIG. 1. The cutting edge 332 is used for cutting when the cutting insert 30 is mounted on the body 20 in a different direction from FIG. 1.

The cutting edge 331 that extends along the side 311, the cutting edge 332 that extends along the side 312, and the breakers 341 and 342 are also disposed around the first constraining surface 3108 in the same manner as the above description, although this is not illustrated. In other words, a total of four cutting edges are disposed in one cutting insert 30, and one is used for cutting. The cutting edge used for cutting is switched depending on the direction of the cutting insert 30, or the like.

A flank 351 is formed at a position adjacent to the cutting edge 331 in the rotating direction. As illustrated in FIG. 3, the flank 351 roughly has a triangular surface formed to extend from the cutting edge 331 toward a corner portion of the first constraining surface 310B on the second constraining surface 320A side. As illustrated in FIG. 4, a flank 352 is formed on the second constraining surface 320B side of the flank 351. The flank 352 is roughly a triangular surface formed to extend from the cutting edge 332, provided along the side of the first constraining surface 3108, toward a corner portion of the first constraining surface 310A on the second constraining surface 320B side.

As illustrated in FIG. 3 and FIG. 4, a third constraining surface 361 is disposed between the flank 351 and the flank 352 in the cutting insert 30. The third constraining surface 361 is a surface that is perpendicular to the second constraining surface 320. The flank 351 and the flank 352 have symmetric shapes to each other, with the third constraining surface 361 therebetween.

As illustrated in FIG. 5 and FIG. 6, flanks 353 and 354 are formed on the opposite side of the flanks 351 and 352. The flank 353 is roughly a triangular surface formed to extend from the cutting edge 331, which is disposed along the side 311 of the first constraining surface 3108, toward a corner portion of the first constraining surface 310A on the second constraining surface 320A side. The flank 354 is roughly a triangular surface formed to extend from the cutting edge 332, which is disposed along the side 312 of the first constraining surface 310A, toward a corner portion of the first constraining surface 3108 on the second constraining surface 320B side. A third constraining surface 362 is disposed between the flank 353 and the flank 354. The third constraining surface 362 is a surface that is perpendicular to the second constraining surface 320. The flank 353 and the flank 354 have symmetric shapes to each other, with the third constraining surface 362 therebetween.

The shape of the flank 353 is the same as (congruent with) the shape of the flank 351. The shape of the flank 354 is the same as (congruent with) the shape of the flank 352, and the shape of the third constraining surface 362 is the same as (congruent with) the shape of the third constraining surface 361. Therefore if the cutting insert 30 is rotated 180° around the center axis AX2, the flank 353 is completely superimposed on the position of the flank 351 before the rotation, the flank 354 is completely superimposed on the position of the flank 352 before the rotation, and the third constraining surface 362 is completely superimposed on the position of the third constraining surface 361 before the rotation.

In the state in FIG. 1, the third constraining surface 362 is in contact with the body 20, whereby the position of the cutting insert 30 in the direction along the rotational center axis AX1 is constrained. In the case where the cutting insert 30 is mounted in a state of being inverted 180° around the center axis AX2, the third constraining surface 361 is in contact with the body 20, whereby the position of the cutting insert 30 is constrained. As described above, either one of the third constraining surfaces 361 and 362 becomes a surface in contact with the body 20 and is constrained thereby.

By the above configuration, the shape of the cutting insert 30 after being rotated 180° around a predetermined symmetrical axis (center axis AX2 in this case), is completely superimposed on the shape of the cutting insert 30 before the rotation. The shape of the cutting insert 30, after being rotated 180° around the symmetrical axis is also completely superimposed on the shape of the cutting insert 30 before the rotation, in the case where the “symmetrical axis” is an axis that passes through the center of the cutting insert 30 and is perpendicular to the center axis AX2, or is an axis that faces the rotating direction (axis AX3 in FIG. 3).

The other configuration of the cutting insert 30 will be described next. As illustrated in FIG. 3, in the cutting insert 30, a margin 371 is disposed in an outermost peripheral portion in the state of FIG. 1. The margin 371 is a portion that contacts with the inner side surface of the hole of the workpiece when machining is performed in the state of FIG. 1. By the margin 371 contacting the inner side surface, traveling straightness of the cutting tool 10 is ensured. The margin 371 linearly extends along the side of the second constraining surface 320A on the first constraining surface 310A side. An adjustment surface 343 is disposed between the margin 371 and the first constraining surface 310A.

Since the cutting insert 30 has a symmetric shape, as mentioned above, a margin 372 having the same shape as the margin 371 is disposed along the side of the second constraining surface 320B on the first constraining surface 310A side. Further, an adjustment surface 344 having the same shape as the adjustment surface 343 is disposed between the margin 372 and the first constraining surface 310A. Identical-shaped margins 371 and 372 and the identical-shaped adjustment surfaces 343 and 344 are also disposed on the first constraining surface 3108 side out of the cutting insert 30 (not illustrated).

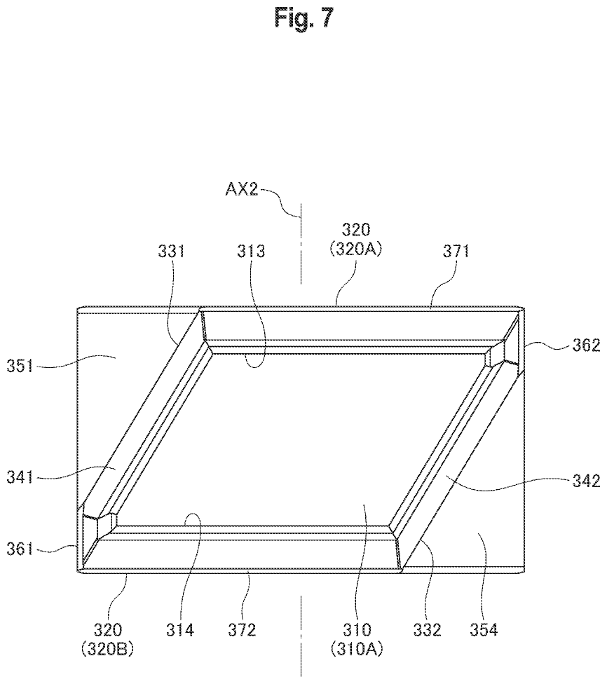

FIG. 7 indicates a shape of the cutting insert 30 viewed along the normal line direction of the first constraining surface 310A. In the view from this direction, the external shape of the cutting insert 30 as a whole is roughly rectangular, and the flank 351 and the flank 354 are speared out from the cutting edge 331 and the cutting edge 332 respectively. In other words, the angle formed by the first constraining surface 310A and the flank 351, which are adjacent to each other with the cutting edge 331 therebetween, is larger than 90°. In the same manner, the angle formed by the first constraining surface 310A and the flank 354, which are adjacent to each other with the cutting edge 332 therebetween, is also larger than 90°. The angle formed by the first constraining surface 3108 and the flank 352 and the angle formed by the first constraining surface 3108 and the flank 353 are also the same (larger than 90°).

By making each of the above angles larger than 90°, the first constraining surface 310A and the first constraining surface 310B can be connected with the flank 351 etc., while considering the disposition of the cutting edge 331 etc., so that each of the first constraining surface 310A and the first constraining surface 310B roughly become a parallelogram.

Here if the angle formed by the 2 surfaces on both sides of the cutting edge 331 etc. is an obtuse angle, as mentioned above, it may become difficult to ensure a “rake angle” during machining, as in a conventional manner.

Therefore in the cutting insert 30 according to Embodiment 1, the breaker 341 etc. is disposed near the cutting edge 331 etc., so that the above mentioned problem is solved.

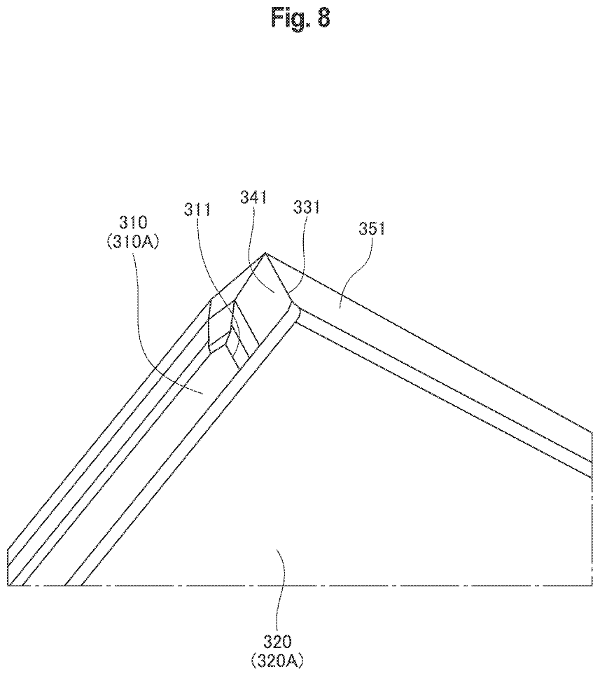

The breaker 341 is disposed adjacent to the cutting edge 331. Therefore, as illustrated in FIG. 8, the angle formed between the inner surface of the breaker 341 and the flank 351, that are adjacent to each other with the cutting edge 331 therebetween, is 90° or less. In other words, the breaker 341 is formed so that this angle becomes 90° or less. Thereby the shape near the cutting edge 331 becomes a shape similar to the conventional shape, and the “rake angle” during machining can be ensured as in a conventional manner.

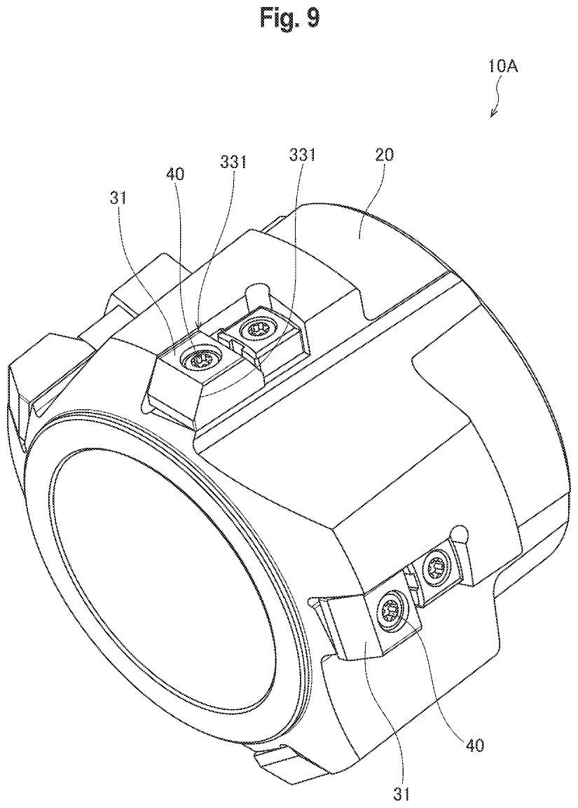

FIG. 9 indicates a configuration of a cutting tool 10A according to a comparative example. In FIG. 9, the reference sign “31” denotes a cutting insert 31 disposed in the cutting tool 10A. A main difference of the cutting tool 10A from Embodiment 1 is the shape of the cutting insert 31. As illustrated in FIG. 9, in this comparative example, the cutting insert 31 has a shape of which cross-section is a trapezoid, and cutting edges 331 are formed at two diagonal positions respectively.

In the case of this configuration of the comparative example, the cutting edge 331 that is used for cutting can be switched by mounting the cutting insert 31 rotating 180° around the screw 40. However unlike Embodiment 1, the cutting insert 31 cannot be mounted in a reversed state. In the comparative example, a number of cutting edges mounted on one cutting insert 31 is two.

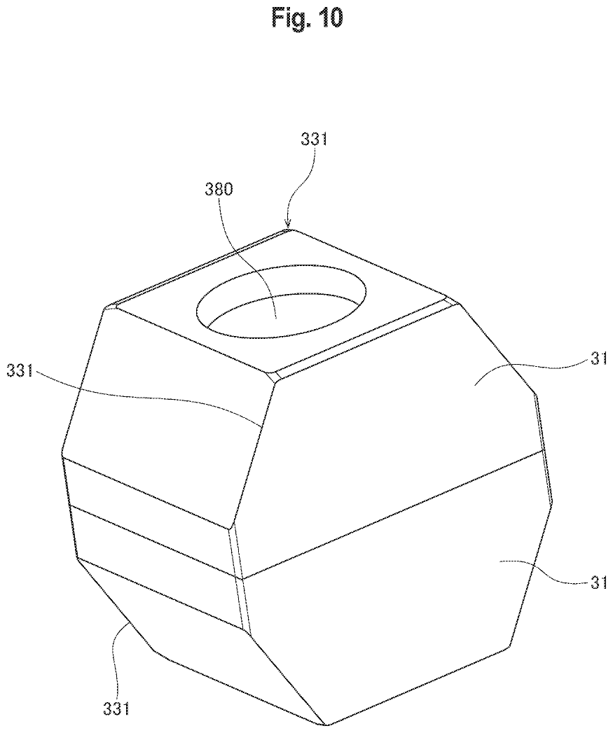

In order to mount four cutting edges on one cutting insert 31, just like Embodiment 1, it is possible to configure the cutting insert by superimposing and integrating two cutting inserts 31, as illustrated in FIG. 10, for example. However, in this configuration, the cutting insert may become too thick, and machining a small diameter workpiece may become difficult.

In Embodiment 1, on the other hand, the first constraining surface 310A etc. is roughly a parallelogram, hence a total of four cutting edges can be switched and used while reducing the thickness of the cutting insert 30. This configuration can be implemented by making the angle between the first constraining surface 310A and the flank 351 etc. to be larger than 90°, as mentioned above.

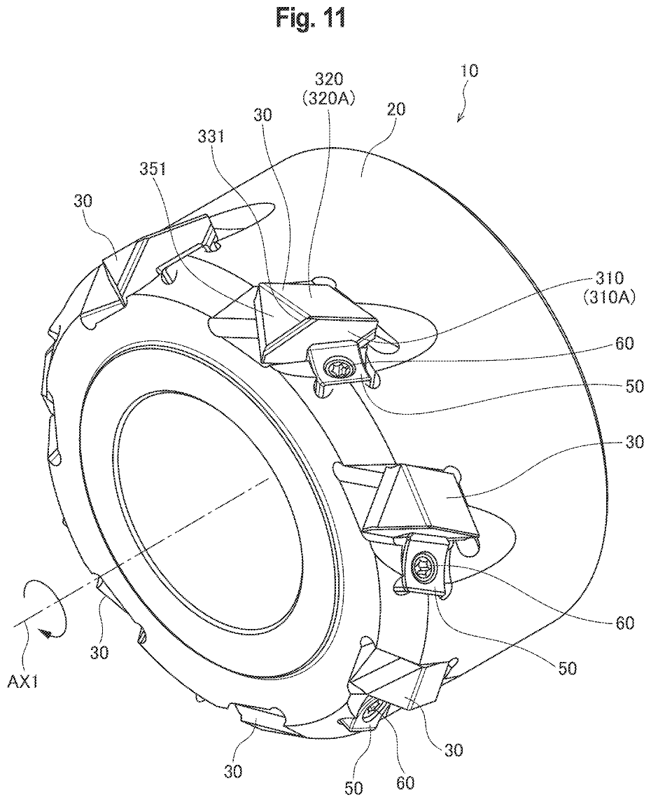

Embodiment 2 will be described with reference to FIG. 11. In the following, aspect that are different from Embodiment 1 will be mainly described, and description on aspects that are the same as Embodiment 1 will be omitted unless necessary.

In a cutting insert 30 of Embodiment 2, the through hole 380, to fasten the cutting insert 30, is not formed. Except for this aspect, the cutting insert 30 of Embodiment 2 is the same as the cutting insert 30 of Embodiment 1.

As illustrated in FIG. 11, the cutting insert 30 is mounted on the body 20 using a fastening member 50. The fastening member 50 is a member for fastening the cutting insert 30 to the body 20 using the screw 60. The fastening member 50 deforms in the direction to the cutting insert 30 as the screw 60 is tightened, so as to apply force to the first constraining surface 310 of the cutting insert 30. This fastening member 50 is also called a “wedge”. The cutting insert 30 of Embodiment 2 is inserted between the body 20 and the fastening member 50, so as to be fastened to the body 20. In the case of fastening the cutting insert 30 by this method as well, the effect described in Embodiment 1 can be implemented.

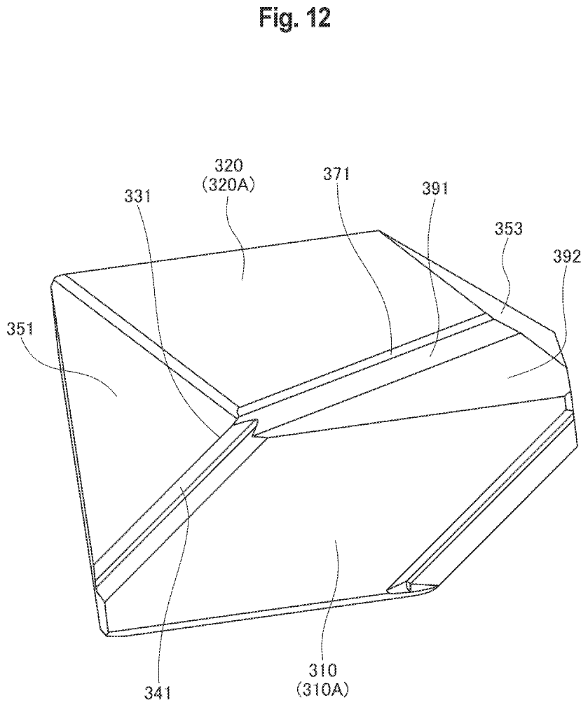

Embodiment 3 will be described next with reference to FIG. 12. In the following, aspects that are different from Embodiment 1 will be mainly described, and description on aspect that are the same as Embodiment 1 will be omitted unless necessary.

In a cutting insert 30 of Embodiment 3, a state of the adjustment surface disposed along the margin 371 is different from Embodiment 1. As illustrated, in FIG. 12, adjustment surfaces 391 and 392 are disposed in Embodiment 3, instead of the adjustment surface 343 illustrated in FIG. 3. The adjustment surface 392 is formed so that the width thereof gradually increases in the direction from the flank 351 to the flank 353. As a result, Embodiment 3 is different from Embodiment 1 in the direction where the linear margin 371 extends.

In the state of being mounted on the body 20, the margin 371 of Embodiment 3 is formed to be parallel with the rotational center axis AX1 of the body 20. In other words, the adjustment surfaces 391 and 392 are formed so that the margin 371 extends in this direction.

Since the margin 371 is parallel with the rotational center axis AX1 in Embodiment 3, the distance from each part of the margin 371 to the inner side surface of the hole can generally be maintained evenly, even if the body 20 rotates during machining. Therefore the function of the margin 371 can be sufficiently expressed in the entire margin 371 in the longitudinal direction.

In the example illustrated in FIG. 12, the through hole 380 penetrating the cutting insert 30 is not formed, just like Embodiment 2 (FIG. 11). Instead of this aspect, the configuration of Embodiment 3 may be applied to the cutting insert 30 in Embodiment 1 where the through hole 380 is formed.

Embodiments have been described with reference to specific examples. However, the present disclosure is not limited to these specific examples. These specific examples, to which an expert skilled in the art added appropriate design changes are included in the scope of the present disclosure, as long as the characteristics of the present disclosure are provided. Each element of each of the above mentioned specific examples, and the positions, conditions, shapes and the like thereof are not limited to the examples described above, but may be changed as required. Each element of each of the above mentioned specific examples may be combined in an appropriate manner, as long as no technical inconsistency is generated.

What is claimed:

1. A cutting insert which is capable of being mounted on a body of a cutting tool, the cutting insert comprising:
First constraining surfaces, which are a pair of surfaces facing each other in a rotating direction of the body, and one of which is constrained by the body;
second constraining surfaces, which are a pair of surfaces facing each other in a direction toward a rotational center axis of the body, and one of which is constrained by the body;
cutting edges disposed respectively along a pair of sides, which extend from one of the second constraining surfaces to the other of the second constraining surfaces and are located at positions facing each other, of sides framing the first constraining surface; and
flanks which are disposed at positions adjacent to the cutting edges respectively in the rotating direction, wherein
an angle formed by the first constraining surface and the flank, which are adjacent to each other across the cutting edge, is larger than 90°.

2. The cutting insert according to claim 1, wherein
a breaker is disposed between the cutting edge and the first constraining surface, and
an angle formed by an inner surface of the breaker and the flank, which are adjacent to each other across the cutting edge is 90° or less.

3. The cutting insert according to claim 1, wherein
in a case where, of the sides framing the first constraining surface, a side on the second constraining surface side is a first side, and a side on the cutting edge side thereof is a second side,
an angle formed by the first side and the second side is an angle that is different from 90°.

4. The cutting insert according to claim 1, wherein
shapes of the two first constraining surfaces are the same as each other, and
shapes of the two second constraining surfaces are the same as each other.

5. The cutting insert according to claim 4, wherein
a shape of the cutting insert after turning 180° around a predetermined symmetric axis is superimposed on a shape before the turning.

6. The cutting insert according to claim 1, wherein
a margin, which is a portion that contacts with an inner side surface of a hole during machining, is formed linearly along the side of the second constraining surface on the first constraining surface side.

7. The cutting insert according to claim 6, wherein
the margin is formed to be parallel with the rotational center axis of the body in a state of the cutting insert being mounted on the body.

8. A cutting tool equipped with the cutting insert according to claim 1.
